(19) United States
(12) Patent Application Publication
(10) Pub. No.: US 2021/0165261 A1
(43) Pub. Date: Jun. 3, 2021

(54) TOUCH DISPLAY PANEL, TOUCH DISPLAY SCREEN AND ELECTRONIC DEVICE

(71) Applicant: BOE TECHNOLOGY GROUP CO., LTD., Beijing (CN)

(72) Inventors: Xiaoliang DING, Beijing (CN); Haisheng WANG, Beijing (CN); Yingming LIU, Beijing (CN); Yanling HAN, Beijing (CN); Wei LIU, Beijing (CN); Changfeng LI, Beijing (CN)

(21) Appl. No.: 16/063,880

(22) PCT Filed: Nov. 10, 2017
(86) PCT No.: PCT/CN2017/110383

§ 371 Date: Jun. 19, 2018

(30) Foreign Application Priority Data
May 16, 2017 (CN) 201710342741.1

(51) Int. Cl. G02F 1/1333; G02F 1/1335; G06F 3/047; G06F 3/044

(52) U.S. Cl. CPC G02F 1/13338; G02F 1/133548; G06F 2203/04105; G06F 3/047; G06F 3/044; G02F 1/133567

(57) ABSTRACT

A touch display panel, a touch screen and an electronic device. The touch display panel includes a first substrate and a plurality of touch sensors located on a light incident side of the first substrate. Each touch sensor includes a plurality of first metal wires arranged in parallel and a second metal wire group connected with the plurality of first metal wires, each touch sensor is connected with a touch detection circuit, and the plurality of first metal wires form a metal wire grid polarizer.

### TECHNICAL FIELD

The present disclosure relates to a touch display panel, a touch display screen and an electronic device.

### BACKGROUND

A touch screen is also called as a “touch control screen” or a “touch control panel”, and is an inductive liquid crystal display device capable of receiving input signals from contacts and the like. When a graphic button on the screen is touched, a touch feedback system on the screen can drive various connection devices according to a pre-programmed configuration, and can be used for replacing a mechanical-button panel, and a vivid audio and video effect is made by means of displaying images by the liquid crystal display. The touch screen serves as a computer input device, and currently a simple, convenient and natural human-computer interaction manner can be achieved via the touch screen. The touch screen can be applied to various electronic devices.

A touch sensor in an existing touch screen generally occupies a large installation space, which makes a shape of the touch screen not thin enough, and affects appearance of the touch screen.

### SUMMARY

Embodiments of the disclosure provide a touch display panel, comprising a first substrate and a plurality of touch sensors located on a light incident side of the first substrate. Each touch sensor includes a plurality of first metal wires arranged in parallel and a second metal wire group connected with the plurality of first metal wires, each touch sensor is connected with a touch detection circuit, and the plurality of first metal wires form a metal wire grid polarizer.

For example, the touch display panel comprises a plurality of pixel-unit groups, each pixel-unit group includes a plurality of pixel units arranged in a matrix, and an orthogonal projection of each touch sensor on the first substrate overlaps with an orthogonal projection of a corresponding one of the pixel-unit groups on the first substrate.

For example, in each touch sensor: the second metal wire group includes a plurality of second metal wires, the plurality of second metal wires are parallel with one other, and is perpendicular to the first metal wires; and an orthogonal projection of an arrangement region for the plurality of first metal wires on the first substrate overlaps with an orthogonal projection of the corresponding one of the pixel-unit groups on the first substrate, and an orthogonal projection of an arrangement region for the plurality of second metal wires on the first substrate overlaps with an orthogonal projection of a non-display region located between two adjacent rows or columns of the pixel units in the corresponding one of the pixel-unit groups on the first substrate.

For example, in each touch sensor: the second metal wire group includes a second metal wire, the second metal wire is perpendicular to the plurality of first metal wires, an orthogonal projection of an arrangement region for the plurality of first metal wires on the first substrate overlaps with an orthogonal projection of a corresponding one of the pixel-unit groups on the first substrate, and an orthogonal projection of an arrangement region for the second metal wire on the first substrate overlaps with an orthogonal projection of a non-display region located between two adjacent rows or columns of the pixel units in the corresponding one of the pixel-unit groups on the first substrate.

For example, an interval between two adjacent touch sensors corresponds to a non-display region between the pixel-unit groups.

For example, the first metal wires in each touch sensor are connected with the touch detection circuit through respective metal leads.

For example, the plurality of touch sensors is arranged on a surface of the first substrate facing the light incident side.

For example, the touch display panel further comprises a second substrate that is arranged on the light incident side of the first substrate and parallel with the first substrate, wherein the plurality of touch sensors is arranged on a surface of the second substrate facing the first substrate.

For example, a signal shielding layer is provided on a light incident side of the second substrate.

For example, the first substrate and the second substrate are connected in a frame bonding manner.

Embodiments of the disclosure further provide a touch display screen, comprising the touch display screen described above.

For example, the touch display screen further comprises a backlight plate located on a light incident side of the touch display panel.

Embodiments of the disclosure further provide an electronic device, comprising the touch display screen described above.

### BRIEF DESCRIPTION OF THE DRAWINGS

In order to illustrate the technical solutions in the embodiments of the present disclosure or the existing arts more clearly, the drawings needed to be used in the description of the embodiments or the existing arts will be briefly described in the following; it is obvious that the drawings described below are only related to some embodiments of the present disclosure, for one ordinary skilled person in the art, other drawings can be obtained according to these drawings without making other inventive work.

FIG. 1 is a structural schematic diagram of a touch display panel provided by an embodiment of the disclosure;

FIG. 2 is a schematic diagram illustrating a positional relationship of a touch sensor and pixel units in a corresponding pixel-unit group provided by an embodiment of the disclosure;

FIG. 3 is a schematic diagram illustrating a positional relationship of two adjacent touch sensors and corresponding pixel-unit groups provided by an embodiment of the disclosure;

FIG. 4 is a schematic diagram illustrating a connection relationship of touch sensors and a touch detection circuit provided with an embodiment of the disclosure;

FIG. 5 is a structural schematic diagram of another touch display panel provided by an embodiment of the disclosure; and

FIG. 6 shows a graph illustrating a work principle of a metal wire grid polarizer provided by an embodiment of the disclosure.

### REFERENCE SIGNS

1—first substrate; 2—first metal wire; 3—second metal wire; 4—metal lead; 5—pixel unit; 6—metal middle frame; 7—second substrate; 8—touch sensor; 9—elastic spacer; 10—signal shielding layer; 11—common electrode; 12—touch detection circuit; 13—backlight plate; 14—pixel-unit group; 20—component group of first array substrate; 21—component group of second array substrate; 22—array substrate; 24—color filter substrate; 26—upper polarizing plate; 30—liquid crystal layer; 201—first group of first metal wires; 202—second group of first metal wires.

### DETAILED DESCRIPTION

Hereafter, the technical solutions of the embodiments of the present disclosure will be described in a clearly and fully understandable way in connection with the drawings related to the embodiments of the disclosure. It is obvious that the described embodiments are just a part but not all of the embodiments of the present disclosure. Based on embodiments of the present disclosure, all other embodiments obtained by those skilled in the art without making other inventive work should be within the scope of the present disclosure.

The embodiments of the present disclosure provide a touch display panel that is simple in structure and low in cost, a touch display screen having the touch display panel and an electronic device having the touch display screen. In the embodiments of the present disclosure, a touch sensor is formed by a plurality of first metal wires and a second metal group, is simple in structure and easy to prepare, and can achieve a touch function. Furthermore, the plurality of first metal wires can also form a metal wire grid polarizer serving as a lower polarizing plate of the touch display panel, and plays a light polarizing role on a light incident side of the touch display panel, so that there is no need to arrange a lower polarizing sheet on the light incident side of the touch display panel, which reduces a size of the touch display panel to a great extent.

Hereinafter, the embodiments of the present disclosure are described in detail in combination with the drawings.

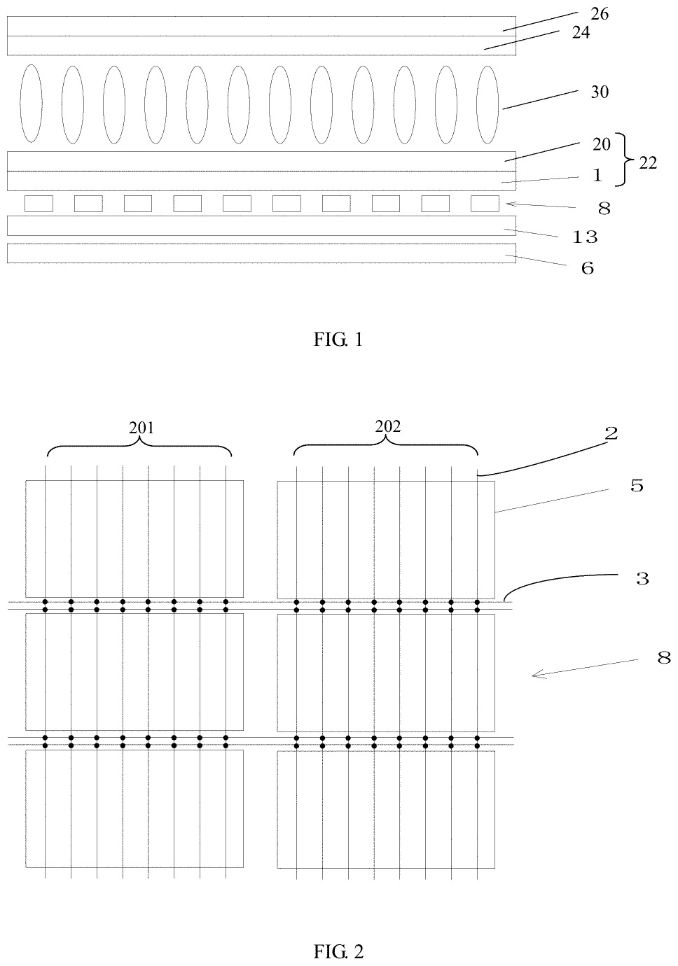

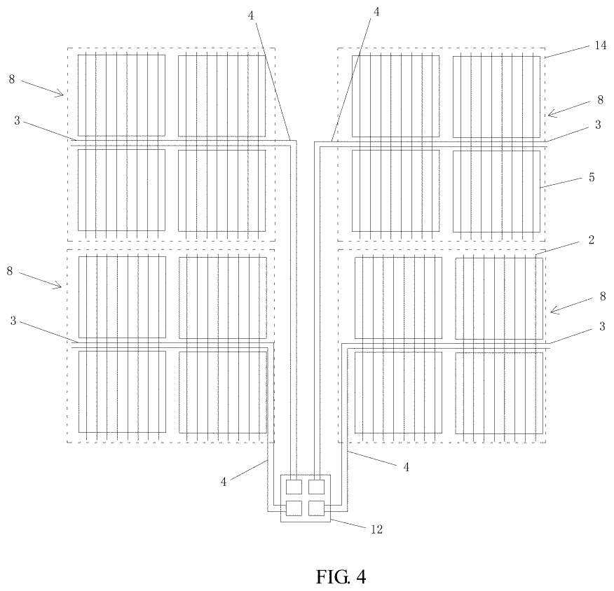

FIG. 1 is a structural schematic diagram of a touch display panel provided by an embodiment of the disclosure. As shown in FIG. 1, the touch display panel comprises a first substrate 1 and a plurality of touch sensors 8 located on a light incident side of the first substrate 1. The plurality of touch sensors 8 are connected with a touch detection circuit 12 (as shown in FIG. 4). Each touch sensor 8 includes a plurality of first metal wires 2 arranged in parallel and a second metal wire group connected with the plurality of first metal wires 2. For example, the second metal wire group in each touch sensor 8 can include one or more second metal wires 3. The plurality of first metal wires 2 can form a metal wire grid polarizer which can be used for playing a light polarizing role on the light incident side of the touch display panel.

In an embodiment of the present disclosure, the plurality of first metal wires 2 form a metal wire grid polarizer that serves as a lower polarizing plate of the touch display panel, and plays a light polarizing role on a light incident side of the touch display panel, so that there is no need to arrange a lower polarizing sheet on the light incident side of the touch display panel, which reduces the size of the touch display panel to a great extent, and also improves a transmission rate.

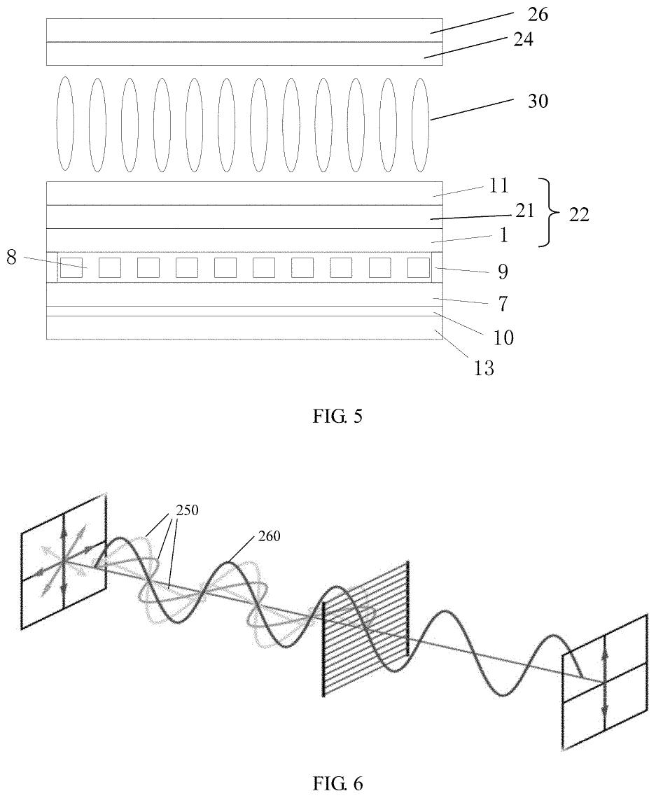

FIG. 6 shows a graph illustrating a work principle of a metal wire grid polarizer provided by an embodiment of the disclosure. The metal wire grid polarizer includes a group of regularly-arranged metal wires (for example, including horizontal first metal wires 2); for electromagnetic waves with an electric field direction parallel with the metal wires, the metal wire grid polarizer has characteristics of high reflection and strong absorption (for example, electromagnetic waves 250 are reflected or absorbed); for electromagnetic waves with an electric field direction perpendicular to the metal wires, the metal wire grid polarizer has characteristics of high transmission and low absorption (for example, electromagnetic waves 260 transmits through the metal wire grid polarizer). The work principle of the metal wire grid polarizer makes a polarizing effect of the metal wire grid polarizer less dependent on a wavelength and an incidence angle, and the metal wire grid polarizer can be applied to a wideband spectrum.

For example, as shown in FIG. 1, the touch display panel further comprises an array substrate 22, a liquid crystal layer 30 and a color filter substrate 24. The array substrate 22 includes a first substrate I and a component group 20 of the array substrate. For example, the component group 20 of the array substrate includes switch transistors, pixel electrodes, common electrodes and other components belonging to the array substrate, which is not limited herein by the disclosure. On the color filter substrate 24, there is further arranged an upper polarizing plate 26, for playing a light polarizing role on a light exit side of the touch display panel.

Further, the touch display panel comprises a plurality of pixel-unit groups 14, each pixel-unit group 14 includes a plurality of pixel units 5 arranged in a matrix. For example, the touch display panel has a plurality of pixel units 5, the plurality of pixel units 5 are divided into a plurality of pixel-unit groups 14, and each pixel-unit group 14 has multiple rows and multiple columns of pixel units 5. An orthogonal projection of each touch sensor 8 on the first substrate 1 overlaps with an orthogonal projection of a corresponding pixel-unit group 14 on the first substrate 1; that is to say, each touch sensor 8 is configured to sense a touch operation in a region where one pixel-unit group 14 is located. In order to effectively guarantee that the touch display panel can quickly and accurately recognize a touch point and/or touch pressure, so that a system can sensitively respond to the touch operation to improve a user experience, a region in which each touch sensor 8 senses for touch should not be too big or too small; that is to say, the pixel units 5 included in each pixel-unit group 14 should not be too many or too few, which can be specifically set according to a needed touch precision. In addition, the number of pixel units 5 included in each pixel-unit group 14 can be a fixed value or a variable value, which can be specifically adjusted correspondingly according to an actual application condition. For example, the numbers of the pixel units 5 included in different pixel-unit groups 14 can be different.

A shape and an arrangement direction of the second metal wire 3 are not limited, and for example, the second metal wire 3 can be a fold line shape and the like, as long as the plurality of first metal wires 2 can be electrically connected, and the second metal wire 3 can cooperate with the first metal wires 2 to achieve a function of sensing and recognizing a touch operation.

FIG. 2 is a schematic diagram illustrating a positional relationship of a touch sensor and pixel units 5 in a corresponding pixel-unit group in an embodiment of the disclosure. As shown in FIG. 2, the second metal wire group includes a plurality of second metal wires 3, the plurality of second metal wires 3 can be arranged in parallel with one other, and is perpendicular to the first metal wires 2. That is to say, the first metal wires 2 and the second metal wires 3 cooperate with each other to form a grid shape (which can be a regular grid shape or an irregular grid shape).

In an embodiment of the present disclosure, an arrangement region of the first metal wires 2 in each touch sensor 8 can be aligned with a corresponding pixel-unit group 14. For example, the plurality of first metal wires 2 in the same touch sensor 8 is divided into a plurality of groups; an arrangement region of each group of the first metal wires 2 is aligned with one column or one row of the pixel units 5; that is to say, an orthogonal projection of an arrangement region for the group of the first metal wires 2 on the first substrate 1 overlaps with an orthogonal projection of an arrangement region for the column or the row of the pixel units 5 on the first substrate 1. As shown in FIG. 2, the plurality of first metal wires 2 in a same touch sensor 8 is divided into a first group 201 of first metal wires and a second group 202 of first metal wires; an orthogonal projection of an arrangement region for the first group 201 of first metal wires on the first substrate 1 overlaps with an orthogonal projection of a first column of pixel units 5 on the first substrate 1; and an orthogonal projection of an arrangement region for the second group 202 of first metal wires on the first substrate 1 overlaps with an orthogonal projection of a second column of pixel units 5 on the first substrate 1.

With further reference to FIG. 2, each pixel-unit group 14 can include a same number of pixel units 5. The plurality of first metal wires 2 (in FIG. 2) in each touch sensor 8 extends longitudinally, and is divided into a plurality of groups, and an arrangement region of each group of the first metal wires 2 is respectively aligned with one column of the pixel units 5. An arrangement region of the second meal wires 3 (namely, the second metal wires 3 in the second metal wire group of each touch sensor 8) is aligned with a non-display region located between two adjacent rows or columns of the pixel units 5 in the pixel-unit group 14. That is to say, an orthogonal projection of an arrangement region of the second metal wires 3 on the first substrate 1 overlaps with an orthogonal projection of the non-display region between two adjacent rows or columns of pixel units 5 on the first substrate 1, so as to prevent the second metal wires 3 from affecting a light polarizing effect of the first metal wires 2 and a display effect of the pixel units 5.

As shown in FIG. 2, the second metal wires 3 in an embodiment extend horizontally between two adjacent rows of pixel units 5 in each touch sensor 8. For example, in the touch sensor as shown in FIG. 2, the second metal wire group includes a plurality of second metal wires 3, the plurality of second metal wires 3 is perpendicular to the plurality of first metal wires 2, and an orthogonal projection of an arrangement region of the plurality of second metal wires 3 on the first substrate 1 overlaps with an orthogonal projection of the non-display region located between two adjacent rows or columns of pixel units 5 in a corresponding pixel-unit group 14 on the first substrate 1. The number of the second metal wires 3 located between two adjacent rows of pixel units 5 can be one or multiple, and can be determined according to an actual scenario.

For example, in each touch sensor, the second metal wire group includes a second metal wire, and the second metal wire is perpendicular to the plurality of first metal wires. An orthogonal projection of an arrangement region of the plurality of first metal wires on the first substrate overlaps with an orthogonal projection of a corresponding one of the pixel-unit groups on the first substrate, and an orthogonal projection of an arrangement region of the second metal wire on the first substrate overlaps with an orthogonal projection of a non-display region located between two adjacent rows or columns of pixel units in the corresponding one of the pixel-unit groups on the first substrate.

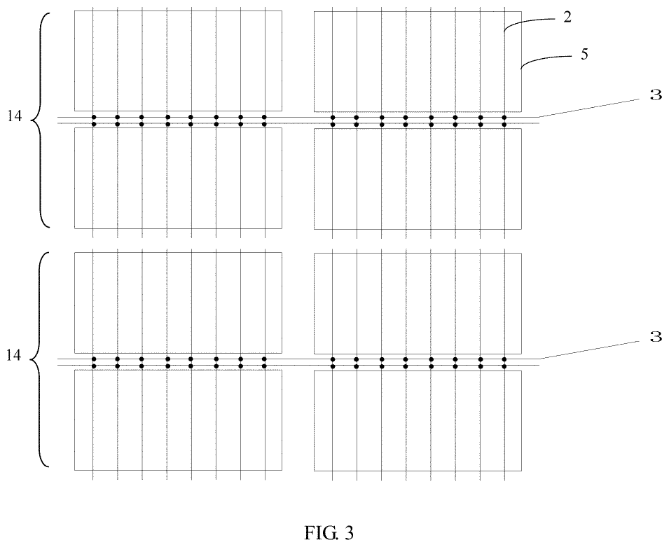

FIG. 3 is a schematic diagram illustrating a positional relationship of two adjacent touch sensors and two corresponding adjacent pixel-unit groups 14 in an embodiment of the disclosure. As shown in FIG. 3, no metal wire is provided in an interval between the two adjacent touch sensors, and the interval between the two adjacent touch sensors is aligned with a non-display region between the two pixel-unit groups 14, so as to guarantee the display effect of the pixel units while implementing a touch function and light polarizing. For example, an orthogonal projection of the interval between the two adjacent touch sensors 8 on the first substrate overlaps with an orthogonal projection of the non-display region between the two pixel-unit groups 14 on the first substrate 1.

FIG. 4 is a schematic diagram illustrating a connection relationship of touch sensors and a touch detection circuit 12 in an embodiment of the disclosure. The touch detection circuit 12 can be an integrated circuit. The touch detection circuit 12 is configured to perform touch detection according to signals sensed by respective touch sensors 8. As shown in FIG. 4, each second metal wire 3 in a respective touch sensor 8 is connected with a metal lead 4, and each metal lead 4 is electrically connected with the touch detection circuit 12, so as to achieve accurate measurement of the touch sensors 8 by the touch detection circuit 12 (in order to facilitate illustration of each metal lead 4 in FIG. 4, an interval between the two columns of touch sensors 8 is exaggerated in FIG. 4; that is to say, an interval between the touch sensors 8 in FIG. 4 is only illustrated by way of examples and does not serve as a limitation for an actual interval between the touch sensors 8).

Further, when the touch display panel is applied to different electronic devices, the touch sensors 8 can be set in different forms, which are illustrated in detail through two examples below:

### EXAMPLE I

In combination with FIG. 1, there is illustrated with a case when the touch display panel in an embodiment of the disclosure is applied to a mobile phone. A mobile phone shell generally has a metal middle frame 6. The plurality of touch sensors 8 in the touch display panel in an embodiment of the disclosure can be arranged on a surface of the first substrate 1 facing the light incident side. When a user performs a touch operation on the touch display panel, an interval between the first substrate 1 and the metal middle frame 6 changes, that is to say, an interval between a touch sensor 8 and the metal middle frame 6 changes, and then a capacitance between the touch sensor 8 and the metal middle frame 6 changes. The touch detection circuit 12 measures a touch position and/or a touch pressure by detecting a changed capacitance value, and responds to the touch operation by the user.

### EXAMPLE II

FIG. 5 is a structural schematic diagram of another touch display panel provided by an embodiment of the disclosure. In combination with FIG. 5, there is illustrated with a case when the touch display panel in an embodiment of the disclosure is applied to an electronic device such as a mobile phone or other electronic devices without a middle frame. In an embodiment of the disclosure, a second substrate 7 parallel with the first substrate 1 can be arranged on a light incident side of the first substrate I, an elastic spacer 9 (such as a rubber elastic pad) is arranged between the first substrate 1 and the second substrate 7. The first substrate 1 and the second substrate 7 are connected in a frame bonding manner, so that middle parts of the first substrate 1 and the second substrate 7 can move relatively, and meanwhile large dislocation deformation is not likely to occur. The plurality of touch sensors 8 can be arranged on a surface of the second substrate 7 facing the first substrate 1. When a user performs a touch operation on the touch display panel, the first substrate 1 moves towards the second substrate 7 to make an interval between the first substrate 1 and the second substrate 7 be changed. In this case, an interval between the touch sensor 8 and a common electrode 11 changes, so that a capacitance between the touch sensor 8 and the common electrode 11 changes. The touch detection circuit 12 measures the touch position and/or the touch pressure by detecting a changed capacitance value, so as to respond to the touch operation by the user.

In the embodiment as shown in FIG. 5 of the disclosure, in order to prevent an electronic signal below the second substrate 7 from influencing the sensing of the touch sensor 8, and a signal shielding layer 10 (such as an ITO shielding layer) can be arranged on a light incident side of the second substrate 7.

For example, as shown in FIG. 5, the touch display panel further comprises an array substrate 22, a liquid crystal layer 30 and a color filter substrate 24. The array substrate 22 includes the first substrate 1, a component group 21 of the array substrate, and the common electrode 11. For example, the component group 21 of the array substrate includes switch transistors, pixel electrodes and other common components (but not including the common electrodes) belonging to the array substrate. The present disclosure does not limit the composition of the component group 21 of the array substrate. On the color filter substrate 24, there is further provided with an upper polarizing plate 26 for playing a light polarizing role on a light exit side of the touch display panel.

An embodiment of the disclosure further provides a touch display screen, and the touch display screen comprises the touch display panel in any of the above embodiments. By including the above touch display panel, the touch screen in an embodiment of the disclosure can have a small size, and meanwhile can guarantee a touch performance, a light polarizing performance and a display performance.

An embodiment of the disclosure further provides a touch display screen, and the touch display screen comprises the touch display panel in any of the above embodiments and a backlight plate 13 arranged on a light incident side of the touch display panel. A setting position of the backlight plate can be referred to in FIG. 1 and FIG. 5. For example, in FIG. 5, the backlight plate 13 can be arranged on an outer side of a signal shielding layer 10; or, in FIG. 1, the backlight plate 13 can be arranged between the touch sensor 8 and the metal middle frame 6. By including the above touch display panel, the touch screen in an embodiment of the disclosure can have a small size, and meanwhile can guarantee a touch performance, a light polarizing performance and a display performance.

An embodiment of the disclosure further provides an electronic device which comprises any one of the above touch display screens. By including the above touch display panel, the electronic device in an embodiment of the disclosure can have a small size, and meanwhile can guarantee a touch performance, a light polarizing performance and a display performance.

It's to be noted that, in the drawings, for the clarity of the drawings the sizes of layers and areas may be exaggerated. And it can be understood, in the case that a component or a layer called “on” another element or layer, it can be directly on the top of the other elements, or can exist in the middle layer. Besides, it can be understood that, in the case that a component or a layer called “under” another element or layer, it can be directly under the other components, or there are at least two intermediate layers or elements. Besides, it can also be understood that, in the case that a layer or a component called “between” two layers or two elements, it can be the only layer of the two layers or two components, or it also exists at least two intermediate layers or elements. The similar reference marks indicate similar components in the whole text.

In the present disclosure, terms such as “first”, “second” and the like used in the present disclosure do not indicate any sequence, quantity or significance but only for distinguishing different constituent parts. Also, the terms such as “a,” “an,” or “the” etc., are not intended to limit the amount, but indicate the existence of at least one. The terms “comprises,” “comprising,” “includes,” “including,” etc., are intended to specify that the elements or the objects stated before these terms and encompass the elements or the objects and equivalents thereof listed after these terms, but do not preclude the other elements or objects.

The foregoing embodiments merely are exemplary embodiments of the disclosure, and not intended to limit the disclosure, and the protection scope of the disclosure is defined by the claims. Various changes or replacements can be made by those skilled in the art within the protection scope of the disclosure, and shall be covered within the protection scope of the present invention.

The present application claims the priority of the Chinese Patent Application No. 201710342741.1 filed on May 16, 2017, which is incorporated herein by reference in its entirety as part of the disclosure of the present application.

1. A touch display panel, comprising:
a first substrate; and
a plurality of touch sensors located on a light incident side of the first substrate,
wherein each touch sensor includes a plurality of first metal wires arranged in parallel and a second metal wire group connected with the plurality of first metal wires, each touch sensor is connected with a touch detection circuit, and the plurality of first metal wires form a metal wire grid polarizer.

2. The touch display panel according to claim 1, wherein the touch display panel comprises a plurality of pixel-unit groups, each pixel-unit group includes a plurality of pixel units arranged in a matrix, and an orthogonal projection of each touch sensor on the first substrate overlaps with an orthogonal projection of a corresponding one of the pixel-unit groups on the first substrate.

3. The touch display pan& according to claim 2, wherein in each touch sensor:
the second metal wire group includes a plurality of second metal wires, the plurality of second metal wires are parallel with one other, and is perpendicular to the first metal wires; and an orthogonal projection of an arrangement region for the plurality of first metal wires on the first substrate overlaps with an orthogonal projection of the corresponding one of the pixel-unit groups on the first substrate, and an orthogonal projection of an arrangement region for the plurality of second metal wires on the first substrate overlaps with an orthogonal projection of a non-display region located between two adjacent rows or columns of the pixel units in the corresponding one of the pixel-unit groups on the first substrate.

4. The touch display panel according to claim 2, wherein in each touch sensor:
the second metal wire group includes a second metal wire, the second metal wire is perpendicular to the plurality of first metal wires, an orthogonal projection of an arrangement region for the plurality of first metal wires on the first substrate overlaps with an orthogonal projection of a corresponding one of the pixel-unit groups on the first substrate, and an orthogonal projection of an arrangement region for the second metal wire on the first substrate overlaps with an orthogonal projection of a non-display region located between two adjacent rows or columns of the pixel units in the corresponding one of the pixel-unit groups on the first substrate.

5. The touch display panel according to claim 2 an interval between two adjacent touch sensors corresponds to a non-display region between two pixel-unit groups that correspond to the two adjacent touch sensors.

6. The touch display pan& according to claim 1, wherein the first metal wires in each touch sensor are connected with the touch detection circuit through respective metal leads.

7. The touch display panel according to claim 1, wherein the plurality of touch sensors is arranged on a surface of the first substrate facing the light incident side.

8. The touch display panel according to claim 1, further comprising a second substrate that is arranged on the light incident side of the first substrate and parallel with the first substrate, wherein the plurality of touch sensors is arranged on a surface of the second substrate facing the first substrate.

9. The touch display panel according to claim 8, wherein a signal shielding layer is provided on a light incident side of the second substrate.

10. The touch display panel according to claim 9, wherein the first substrate and the second substrate are connected in a frame bonding manner.

11. A touch display screen, comprising the touch display screen according to claim 1.

12. The touch display screen according to claim 11, further comprising a backlight plate located on a light incident side of the touch display panel.

13. An electronic device, comprising the touch display screen according to claim 11.

14. The touch display panel according to claim 3, wherein an interval between two adjacent touch sensors corresponds to a non-display region between two pixel-unit groups that correspond to the two adjacent touch sensors.

15. The touch display panel according to claim 4, wherein an interval between two adjacent touch sensors corresponds to a non-display region between two pixel-unit groups that correspond to the two adjacent touch sensors.

16. The touch display panel according to claim 2, wherein the first metal wires in each touch sensor are connected with the touch detection circuit through respective metal leads.

17. The touch display panel according to claim 3, wherein the first metal wires in each touch sensor are connected with the touch detection circuit through respective metal leads.

18. The touch display panel according to claim 2, wherein the plurality of touch sensors is arranged on a surface of the first substrate facing the light incident side.

19. The touch display panel according to claim 3, wherein the plurality of touch sensors is arranged on a surface of the first substrate facing the light incident side.

20. The touch display panel according to claim 2, further comprising a second substrate that is arranged on the light incident side of the first substrate and parallel with the first substrate, wherein the plurality of touch sensors is arranged on a surface of the second substrate facing the first substrate.
